(19) United States
(12) Patent Application Publication
(10) Pub. No.: US 2012/0060956 A1
(43) Pub. Date: Mar. 15, 2012

(54) CONNECTION BOX FOR A DUCT SYSTEM IN A VENTILATION OR AIR-CONDITIONING INSTALLATION

(76) Inventors: Lukas Zwiernik, Duisburg (DE); Thomas Wolters, Erkelenz (DE)

(21) Appl. No.: 13/229,893

(22) Filed: Sep. 12, 2011

(30) Foreign Application Priority Data
Sep. 10, 2010 (EP) 10176242.5

(51) Int. Cl. F16L 37/00

(52) U.S. Cl. 137/798

(57) ABSTRACT

The invention relates to a connection box for an air line in a ventilation or air-conditioning installation, having a housing which comprises a housing wall consisting of a plurality of housing-wall regions, said housing having at least one inlet and at least one outlet. The housing can be collapsed, pushed together and/or folded in order to reduce the volume taken up by the housing, and that in the region of the inlet there is provided a flap which is mounted in the inlet such that it can pivot about a shaft or axle, which is arranged in particular centrally with respect to the opening, between an open position and a closed position and extends in its closed position at least over a substantial part of the flow cross section of the inlet, in particular completely closes the flow cross section of the inlet.

### CROSS-REFERENCE TO RELATED APPLICATIONS AND CLAIM TO PRIORITY

This application is related to application number 10176242.5, filed Sep. 10, 2010 in the Federal Republic of Germany, the disclosure of which is incorporated by reference and to which priority is claimed.

### FIELD OF THE INVENTION

The invention relates to a connection box for an air line in a ventilation or air-conditioning installation, having a housing which comprises a housing wall consisting in particular of a plurality of housing-wall regions, said housing having at least one inlet and at least one outlet.

### BACKGROUND OF THE INVENTION

Connection boxes of this kind usually serve for connecting air passages, e.g. floor passages, wall passages or ceiling passages. The supply air supplied by the ventilation or air-conditioning installation flows into the room to be ventilated through the connection box and the air passage arranged on the room-side thereof.

Arranged regularly upstream of the connection box in the flow direction is a throttle flap, which is formed as a separate component and which has to be installed in the air-conditioning installation—as does the connection box. Mounting is time consuming and is only possible to a limited extent on account of the sometimes very restricted on-site space conditions that are available.

### SUMMARY OF THE INVENTION

The object of the invention is to avoid the abovementioned disadvantages and to specify a connection box which allows easier mounting.

This object is achieved in that the housing of the connection box can be collapsed, pushed together and/or folded in order to reduce the volume taken up by the housing, in particular for transporting, and in that in the region of the inlet there is provided a flap which is mounted in the inlet such that it can pivot about a shaft or axle, which is arranged in particular centrally with respect to the opening, between an open position and a closed position and extends in its closed position at least over a substantial part of the flow cross section of the inlet, in particular completely closes the flow cross section of the inlet. In the configuration according to the invention, the flap is located in a plane with the housing wall.

Therefore, the flap is integrated into the connection box. The flap can be already mounted at the factory. Then, the unit is transported to the site and merely has to be connected on site as a unit to the on-site ventilation system. This significantly reduces the mounting effort. The integration of the flap into the connection box also reduces the space requirement required on site.

In addition, in the collapsed, pushed-together or folded state, the connection box has small dimensions. Only on site does the connection box attain its actual “operational form” by being opened out, pushed apart and/or unfolded, with the connection box preferably being fixed in this operational form by suitable measures, so that the connection box retains its form even when no medium is flowing through the connection box.

Advantageously, opening out, pushing apart and/or unfolding is possible without technical auxiliary means. The outflow surface of the outlet usually takes up a significant proportion of the relevant surface of the housing-wall region which contains the outlet.

The housing-wall regions of the connection box can be formed as partial regions of a continuous surface and so they merge into one another. In this case, the connection box can have for example the form of a sphere, it being possible for the inlet and outlet to be arranged at any desired points on the sphere surface. Of course, it is also possible for the connection box, in particular if it has an angular configuration, to consist of a plurality of housing-wall regions, which butt against one another, forming edges.

Preferably, the entire housing, apart from the inlet and the outlet, is air-impermeable. This prevents supply air emerging laterally from the connection box or room air being drawn laterally into the connection box as a result of induction.

In a preferred embodiment, in order that a housing-wall region can be collapsed and/or folded easily, this housing-wall region can consist of a flexible, air-impermeable material. A flexible material is understood to be a material such as e.g. textiles, films or the like. These materials can also be formed to be elastic—should this be necessary. Of course, it is possible for only one housing-wall region to consist of the flexible, air-impermeable material. However, it is also possible for a plurality or even all of the housing-wall regions to consist of the flexible, air-impermeable material.

If all the housing-wall regions consist of an air-impermeable material, it is then possible to produce connection boxes of any desired configuration, which can be matched optimally to the local structural conditions.

For the purposes of folding, which usually produces a regular folding pattern, it is possible for folding lines, along which the material is folded, to be provided in each housing-wall region. Of course, collapsing is also possible, however. In this case, the material is collapsed in a more or less “random” manner.

At least one housing-wall region, preferably the housing-wall region which contains the inlet and/or outlet, can be formed in a rigid, in particular plate-like, manner. One possible exemplary embodiment is e.g. a housing-wall region formed from sheet metal, in which for example the inlet is provided.

At least two housing-wall regions adjoining one another along an edge can be formed in a rigid, in particular plate-like, manner and can be connected together in an articulated manner, wherein in particular each housing-wall region that connects the two housing-wall regions together consists of a flexible, air-impermeable material. In such a configuration, the connection box is formed in the manner of a “bellows”. The two rigidly formed housing-wall regions can be folded against one another on account of the articulated connection. In such an embodiment, the other housing-wall region(s), which connect the two rigid housing-wall regions together, is or are preferably made of the flexible, air-impermeable material.

Preferably, at least one supporting element, which holds the flexible, air-impermeable material in a predetermined form, is assigned to the flexible, air-impermeable material. The supporting element can be provided in the material itself, for example in the form of a supporting fabric. Also, the supporting element can be provided both outside and inside the connection box. It can also be a separate supporting element which has to be fastened in an appropriate manner.

It is possible for at least two housing-wall regions, the relative orientation and/or mutual spacing of which can be altered, to be able to be fixed in the operating position with respect to one another by means of a pawl, support rod or the like.

The flexible, air-impermeable material can consist of a fabric, of plastic or the like. Of course, other configurations are possible.

The housing can have a lining made of a sound-absorbing material on the inside.

A detachable air passage can be provided in the outlet. However, it is entirely possible for the air passage to be provided in a fixed manner in the outlet.

The flap can have a multiplicity of, in particular round, through-openings.

In this case, the through-openings can be arranged in a manner distributed uniformly over at least a partial region of the area of the flap.

In order to keep the pressure loss in the region of the through-opening as low as possible, and in order to avoid undesirable noise, it is appropriate for at least one of the two circumferential edge regions of the rim of at least one through-opening to be rounded off and/or for at least one of the two circumferential edge regions of the outer rim of the flap to have a rounded-off form.

In this case, the flap can be arranged in an installation frame having an opening, and the flap and the installation frame can form a mounting unit, and the installation frame and the flap can each be produced from plastic. In such a configuration, the flap and the installation frame are in a plane with the housing wall. Such a mounting unit consisting of a flap and an installation frame is easy to produce since it is produced from plastic. The flap and the opening can have any desired form in respect of the cross-sectional area. For example, the flap and therefore also the opening can have a round or angular form.

Since the flap and the installation frame form a mounting unit produced from plastic, the mounting unit can easily be mounted in the factory and also be easily installed—even on site. If the flap and the shaft form one unit, the mounting unit is formed in two parts. One part is formed by the flap with the shaft, while the installation frame forms the second part.

The shaft and the flap can be formed in one piece, for example made of plastic. However, it is also entirely possible for two shaft stubs to be inserted into corresponding receptacles in the flap, the shaft stubs being arranged such that they cannot rotate with respect to the flap.

If the flap is connected to the installation frame by an axle, it is appropriate for a device for fixing the flap position to be provided.

The installation frame can have a collar which partially surrounds the opening, in particular completely surrounds the opening, and is formed like a socket. The collar channels and supports the flow of air flowing through the opening in the region of the opening.

It is appropriate for the collar to have a recess which receives the shaft or the axle in a latching manner at least in the region of one end of the shaft or of the axle. Thus, for example, the recess can taper towards its base, for example in the manner of a v, in which case the recess, at least in the region of one edge, has a protrusion which, in the latched state of the shaft or of the axle, prevents unintentional release of the shaft or of the axle from the recess.

At least one recess and that end of the shaft which interacts with this recess can be formed such that rotation prevention is provided in the form of an adhesion-improving surface, such as e.g. a coating, or a structure, such as e.g. fluting, such that self-latching adjustment is therefore possible. By way of example, the coating may be a rubber coating. On account of the self-latching adjustment, it is possible for the flap to be easily moved into the desired position during mounting.

An adjustment element for adjusting the flap position can be provided in the region of at least one end of the shaft. The flap is preferably fitted on site such that the adjustment element is accessible from the room, such that the flap position can therefore be changed at any time.

A partial region of the outer rim of the installation frame can have at least one mounting portion which is mounted in an articulated manner, in particular via a film hinge. By means of the mounting portions, the installation frame is fastened to the frame in an articulated manner. For folding purposes, the installation frame, the edges of which are adjoined by the other housing-wall regions, which consist of a flexible, air-impermeable material, is pivoted, together with the flap, which is arranged in the installation frame, into the cavity enclosed by the frame.

At least two pairs of clamping receptacles, which are arranged in a distributed manner, for receiving a marginal region of an air-distributing element formed, for example, in a funnel-like manner can be provided around the opening.

In a preferred embodiment of the invention, the installation frame extends substantially in one plane. Such a configuration is appropriate, in particular, for use in connection boxes in which the housing-wall region into which the flap is to be inserted has a planar form.

### DESCRIPTION OF THE DRAWINGS

Exemplary embodiments of the invention, which are illustrated in the drawing, are explained in the following text. In the drawing:

FIG. 1 shows a connection box according to the invention in the folded state without an inlet connector,

FIG. 2 shows the article according to FIG. 1 with an inlet connector,

FIG. 3 shows the article according to FIG. 2 in the already folded state,

FIG. 4 shows the article according to FIG. 3 in the state fixed by a supporting element (operational position),

FIG. 5 shows an oblique side view of a mounting unit consisting of a flap inserted into an installation frame,

FIG. 6 shows the detail “X” from FIG. 5,

FIG. 7 shows the detail “Y” from FIG. 5

FIG. 8 shows a rear view of a clamping strip and

FIG. 9 shows a section through the article according to FIG. 8.

### DETAILED DESCRIPTION OF THE PREFERRED EMBODIMENT(S)

In all the figures, corresponding reference signs are used for identical or equivalent components.

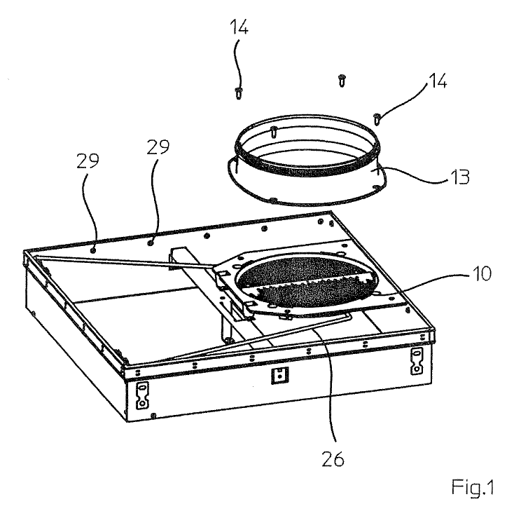

FIGS. 1 to 4 illustrate a connection box for a duct system in a ventilation or air-conditioning installation. The connection box consists, inter alia, of a housing 1, which comprises a housing wall, has an inlet 2, in which a flap 3 is provided, and has an outlet 4. Depending on the exemplary embodiment, the housing wall can have one or more housing-wall regions 5.

By means of the inlet 2, the connection box is connected to a duct system (not illustrated) of a ventilation or air-conditioning installation. The connection box has a circumferential frame 6 made of sheet metal having fastening plates 7. The underside of the frame 6 forms the outlet 4. Mounted in the region of the outlet 4, which faces the room to be ventilated, is an air passage. For mounting purposes, there is provided a crosspiece 8 having a central bore 9, into which a corresponding screw can be screwed. In the exemplary embodiment illustrated, the outlet 4 is in a square form.

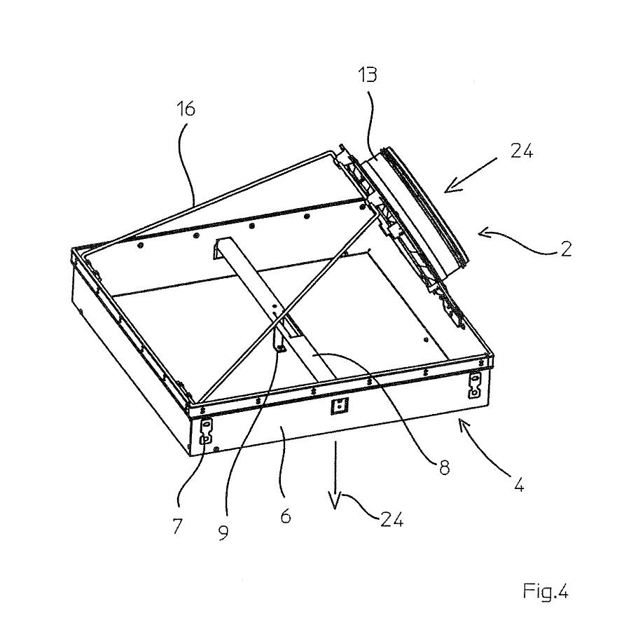

The connection box illustrated in FIGS. 1 to 4 can be folded. The inlet 2 is formed by an opening in an installation frame 10, so that the housing-wall region 5 is formed in a rigid manner in the region of the inlet 2 on account of the installation frame 10 and is connected in an articulated manner, as will be described hereinbelow, to the frame 6. The other housing-wall regions 5, which connect the housing-wall region 5 which is formed in a rigid manner at least in the region of the inlet 2, are made of a flexible, air-impermeable material, such as e.g. a fabric sheet. In the mounted state, i.e. in the operational form illustrated in FIG. 4, the connection box has an approximately triangular form in side view.

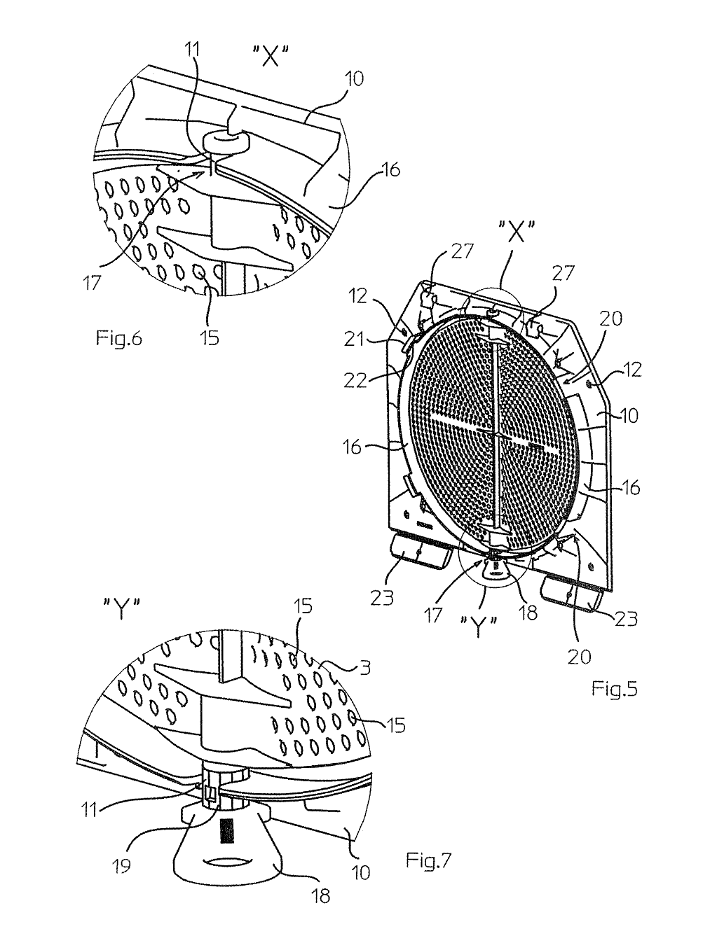

FIGS. 5 to 7 illustrate in detail the flap 3, which is in the form of a throttle flap. The flap 3 is arranged in the installation frame 10 having an opening, with the installation frame 10 extending in one plane in the exemplary embodiment illustrated.

The flap 3 and the installation frame 10 form a mounting unit. The flap 3 is mounted in the opening such that it can pivot about a shaft 11 arranged centrally with respect to the opening. The shaft 11 is rotationally fixed with respect to the flap 3. The installation frame 10 and the flap 3 consist of plastic. The housing-wall region 5 of the connection box is formed in a planar manner at least in the mounting region of the inlet 2, where the installation frame 10 is mounted with the flap 3. For fastening purposes, bores 12 are provided in the installation frame 10. These bores 12 can also serve to fasten an inlet connector 13 by means of screws 14.

As can be gathered from FIGS. 5 to 7, the flap 3 has a multiplicity of round through-openings 15, which are arranged in a manner distributed uniformly over partial regions of the area of the flap 3.

The installation frame 10 has a collar 16 which is formed in a socket-like manner entirely surrounding the opening. In order to mount the shaft 11, which is integrally formed on the flap 3, the collar 16 has in its opposing regions in each case one recess 17 which receives the shaft 11 in a latching manner. Each latching recess 17 prevents the shaft 11 from being able to unintentionally come out of the recess 17.

At the in FIG. 5 lower end of the shaft 11 there is provided an adjusting element 18 in the form of a lever, in order that the position of the flap 3 can be set. The adjusting element 18 is preferably arranged such that it is accessible from the outlet 4. In order to prevent the flap position from being changed unintentionally, the lower recess 17 and that end of the shaft 11 which interacts with the recess 17 are formed such that rotation prevention is provided in the form of a structure. In the exemplary embodiment illustrated, the lower end of the shaft 11 is not in a round form, but has a structure in the form of partial surfaces 19 that are arranged in a manner distributed in an angled manner with respect to one another over the circumference of the shaft 11. The corresponding recess 17 is formed in an appropriate manner.

As can be gathered from FIG. 5, four pairs of clamping receptacles 20 for receiving a marginal region of a funnel-like air-distributing element (not illustrated) are provided around the opening in a manner arranged at an angle of 90° with respect to one another.

Each clamping receptacle 20 consists of two portions 21, 22 which are arranged parallel to one another and form between one another a clamping gap in which the circumferential rim of the air-distributing element is fixed. As can be gathered for example from FIG. 5, in the exemplary embodiment illustrated, that portion 2 of each clamping receptacle 20 which faces the opening is formed by the collar 16 itself.

As can be gathered from FIG. 5, the installation frame 10 has at its outer rim two mounting portions 23, which are connected to the installation frame 10 in an articulated manner via a respective film hinge. These mounting portions 23 serve for mounting the installation frame 10 on the frame 6 of the foldable connection box.

As can be gathered for example from FIG. 1, the flap 3 is mounted in the inlet 2 in the connection box. The mounting portions 23 of the installation frame 10 are in this case fastened to the circumferential frame 6 by way of screws (not illustrated in more detail).

In order to distribute the air flowing in the direction of the arrow 24, an air-distributing element can be provided on that side of the installation frame 10 which is remote from the flow of air, it being possible for said air-distributing element to be formed for example in a funnel-like or conical manner and to consist of an air-permeable fabric, such as a fibrous nonwoven web. In the region of the open end, the air-distributing element can have an encircling ring, which is plugged into the four clamping receptacles 20.

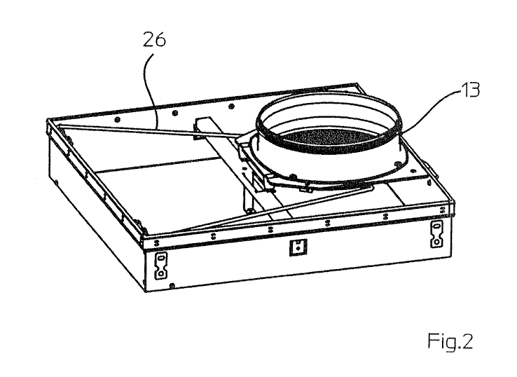

FIG. 1 shows the connection box according to the invention in the folded state without an inlet connector 13. The height of the folded connection box therefore corresponds approximately to the height of the frame 6. As can be gathered from FIG. 1, preferably first of all the inlet connector 13 is fixed to the installation frame 10 by way of the screws 14. Once the inlet connector 13 has been fixed, the situation illustrated in FIG. 2 is set.

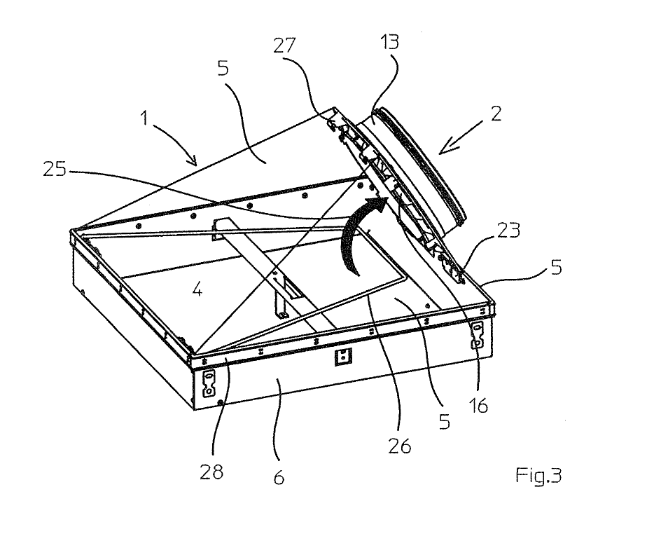

Then, the housing-wall region 5, as is illustrated in FIG. 3, is pivoted up with the inlet 2 in the direction of the arrow 25. As soon as the housing-wall region 5 having the flap 3 has reached its operational position illustrated in FIG. 4, the housing-wall region 5 is fixed by way of a supporting element 26 in the form of a bracket. The two ends of the bracket are fastened in a rotatable manner to the frame 6, while the bracket latches into two corresponding latching receptacles 27 in the installation frame 10 by way of a bracket region oriented parallel to the rotational axis.

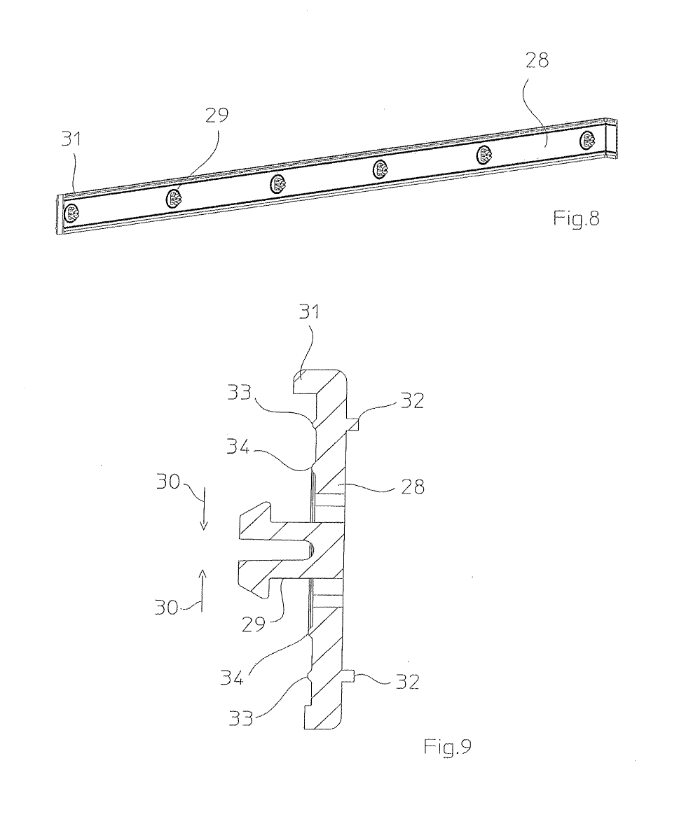

FIGS. 8 and 9 illustrate a clamping strip 28, which is produced for example from plastic, in a rear view and in section, said clamping strip 28 serving to fix the housing-wall regions 5 to the frame 6. As can be gathered for example from FIG. 9, the clamping strip 28 has latching noses 29 for laterally clipping onto the frame 6. Each latching nose 29 engages behind the rim of an opening in the frame 6 in the latched-in state. In the clipped-in state, the housing-wall region 5 is clamped in between the outside of the frame 6 and the clamping strip 28. In order that each latching nose 29 of the clamping strip 28 can be introduced into its corresponding opening in the frame 6, the housing-wall region 5 has in the corresponding region a recess, which is aligned with the opening and through which the latching nose 29 is guided. When the front region of a latching nose 29 is introduced into its corresponding opening in the frame 6, the front region of the latching nose 29 is displaced in the direction of the arrows 30 when it makes contact with the rim of the opening. Once it has passed through the opening, the front region of each latching nose 29 expands again counter to the arrows 30, and so the rim of the respective opening in the frame 6 is engaged behind.

Furthermore, the upper rim has an angled region to the side of the latching noses 29, said angled region 31 pressing the relevant housing-wall region 5 against the upper rim of the frame 6 in the clipped-on state of the clamping strip 28 and thus serving as a sealing strip.

Provided on the outside of the clamping strip 30 are two circumferential stiffening ribs 31. For additional sealing, two spaced-apart sealing edges 33, which extend along the two longitudinal edges, are provided on the side that is in contact with the housing-wall region 5, namely the rear side. In addition, a circumferential edge-like seal 34 is provided around each latching nose 29, in order to prevent air escaping in the region of the latching nose 29.

In order to make it possible to view from above the structural configuration of the inside of the connection box, the housing-wall regions 5 are formed from a transparent film in FIGS. 1 to 4. Of course, an opaque material is also conceivable so that the structural configuration of the inside can then no longer be seen from the outside.

Instead of the shaft 11, it is of course also possible to provide an axle, a separate device for fixing the flap position then being necessary.

Of course, the connection box according to the invention can also be used to remove air by suction in air-extraction operation. In this case, the air to be removed by suction is drawn in via the outlet 4 and passes through the inlet 2 into the connected air line. In this case, no air-distributing element is required.

We claim:

1. Connection box for an air line in a ventilation or air-conditioning installation, having a housing (1) which comprises a housing wall consisting in particular of a plurality of housing-wall regions (5), said housing having at least one inlet (2) and at least one outlet (4), characterized in that the housing (1) of the connection box can be collapsed, pushed together and/or folded in order to reduce the volume taken up by the housing (1), in particular for transporting, and in that in the region of the inlet (2) there is provided a flap (3) which is mounted in the inlet (2) such that it can pivot about a shaft (11) or axle, which is arranged in particular centrally with respect to the opening, between an open position and a closed position and extends in its closed position at least over a substantial part of the flow cross section of the inlet (2), in particular completely closes the flow cross section of the inlet (2).

2. Connection box according to the preceding claim, characterized in that, in order that a housing-wall region (5) can be collapsed and/or folded easily, this housing-wall region (5) consists of a flexible, air-impermeable material.

3. Connection box according to claim 1, characterized in that at least one housing-wall region (5), preferably the housing-wall region (5) which contains the inlet (2) and/or outlet (4), is formed in a rigid, in particular plate-like, manner.

4. Connection box according to claim 1, characterized in that at least two housing-wall regions (5) adjoining one another along an edge are formed in a rigid, in particular plate-like, manner and are connected together in an articulated manner, wherein in particular each housing-wall region (5) that connects the two housing-wall regions (5) together consists of a flexible, air-impermeable material.

5. Connection box according to claim 1, characterized in that at least one supporting element (26), which holds the flexible, air-impermeable material in a predetermined form, is assigned to the flexible, air-impermeable material.

6. Connection box according to claim 1, characterized in that at least two housing-wall regions (5), the relative orientation and/or mutual spacing of which can be altered, can be fixed in the operating position with respect to one another by means of a pawl, support rod or the like.

7. Connection box according to claim 1, characterized in that the flexible, air-impermeable material consists of a fabric, of plastic or the like.

8. Connection box according to claim 1, characterized in that a detachable air passage is provided in the outlet (4).

9. Connection box according to claim 1, characterized in that the flap (3) has a multiplicity of, in particular round, through-openings (15).

10. Connection box according to claim 9, characterized in that the through-openings (15) are arranged in a manner distributed uniformly over at least a partial region of the area of the flap (3).

11. Connection box according to claim 9, characterized in that at least one of the two circumferential edge regions of the rim of at least one through-opening (15) is rounded off.

12. Connection box according to claim 1, characterized in that at least one of the two circumferential edge regions of the outer rim of the flap (3) has a rounded-off form.

13. Connection box according to claim 1, characterized in that the flap (3) is arranged in an installation frame (10) having an opening, in that the flap (3) and the installation frame (10) form a mounting unit, and in that the installation frame (10) and the flap (3) are each produced from plastic.

14. Connection box according to claim 13, characterized in that the installation frame (10) has a collar (16) which partially surrounds the opening, in particular completely surrounds the opening, and is formed like a socket.

15. Connection box according to claim 14, characterized in that the collar (16) has a recess (17) which receives the shaft (11) or the axle in a latching manner at least in the region of one end of the shaft (11) or of the axle.

16. Connection box according to claim 15, characterized in that at least one recess (17) and that end of the shaft (11) which interacts with this recess (17) are formed such that rotation prevention is provided in the form of an adhesion-improving surface, such as e.g. a coating, or a structure, such as e.g. fluting.

17. Connection box according to claim 13, characterized in that an adjustment element (18) for adjusting the flap position is provided in the region of at least one end of the shaft (11).

18. Connection box according to claim 13, characterized in that a partial region of the outer rim of the installation frame (10) has at least one mounting portion (23) which is mounted in an articulated manner, in particular via a film hinge.

19. Connection box according to claim 13, characterized in that at least two pairs of clamping receptacles (20), which are arranged in a distributed manner, for receiving a marginal region of an air-distributing element formed in a funnel-like manner are provided around the opening.

20. Connection box according to claim 13, characterized in that the installation frame (10) extends substantially in one plane.
